(19) United States
(12) Patent Application Publication
(10) Pub. No.: US 2009/0255385 A1
(43) Pub. Date: Oct. 15, 2009

(54) TORQUE WRENCH WITH A COUNTER

(76) Inventor: CHIH-CHING HSIEH, Taichung City (TW)

Correspondence Address: Chien-Hui Su, P. O. Box 70-121 Taichung, Taichung City, 40899, TW

(21) Appl. No.: 12/102,026

(22) Filed: Apr. 14, 2008

(51) Int. Cl. B25B 23/142; G01L 1/22

(52) U.S. Cl. 81/467; 73/862.338

(57) ABSTRACT

A torque wrench includes a handle and a function shaft longitudinally mounted to the handle. The handle has a counter mounted in a middle portion of the handle. The function shaft has a head adapted to drive a workpiece and a connecting rod laterally extending from the head. The connecting rod is received in and engaged to one end of the handle. The function shaft has a torque sensor mounted in the connecting rod and electrically connected to the counter for sensing a torque value from the head, whereby the counter executes a weighted compute and shows date when receiving a signal from the torque sensor.

### BACKGROUND OF THE INVENTION

1. Field of the Invention

The present invention relates to a torque wrench, and more particularly to a torque wrench with a counter for measuring the use frequency of the torque wrench.

2. Description of Related Art

A conventional torque wrench generally does not include a counter which is able to measure and indicate the use frequency thereof. However, the sensitivity of the torque wrench will be gradually reduced due to frequent operation. As time passes, the torque wrench can not measure an accurate torque that the workpiece is applied by the hand tool, and needs to be rectified for a precise operation.

Consequently, some torque wrench manufacturers try to dispose a counter to the torque wrench for measuring the use frequency of the torque wrench. However, the conventional counter for a torque wrench can not do a weighted count when the torque wrench is continually operated and automatically remind the operator after the torque wrench being used for a period of time. It needs to be advantageously altered.

The present invention has arisen to mitigate and/or obviate the disadvantages of the conventional torque wrench without counter and the conventional counter for a torque wrench.

### SUMMARY OF THE INVENTION

The main objective of the present invention is to provide an improved torque wrench that has a counter for measuring use frequency of the torque wrench and automatically reminding the operator after the torque wrench being used for a period of time.

To achieve the objective, the torque wrench in accordance with the present invention comprises a handle and a function shaft longitudinally mounted to the handle. The handle has a counter mounted in a middle portion of the handle. The function shaft has a head adapted to drive a workpiece and a connecting rod laterally extending from the head. The connecting rod is received in and engaged to one end of the handle. The function shaft has a torque sensor mounted in the connecting rod and electrically connected to the counter for sensing a torque value from the head, whereby the counter executes a weighted compute and shows date when receiving a signal from the torque sensor.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a torque wrench with a counter in accordance with the present invention;

FIG. 2 is a perspective view of the torque wrench with a counter in accordance with the present invention;

FIG. 3 is an operational view of the torque wrench in FIG. 2;

FIG. 4a a partial top plan view in cross-section of the torque wrench of the present invention when the torque wrench is in a intermittent operation;

FIG. 4b is a top plan view of a display element the torque wrench the present invention for showing a result of an ordinary count;

FIG. 5a a partial top plan view in cross-section of the torque wrench of the present invention when the torque wrench is continually wrenched for a period of time; and

FIG. 5b is a top plan view of a display element the torque wrench the present invention for showing a result of a weighted count.

### DETAILED DESCRIPTION OF THE INVENTION

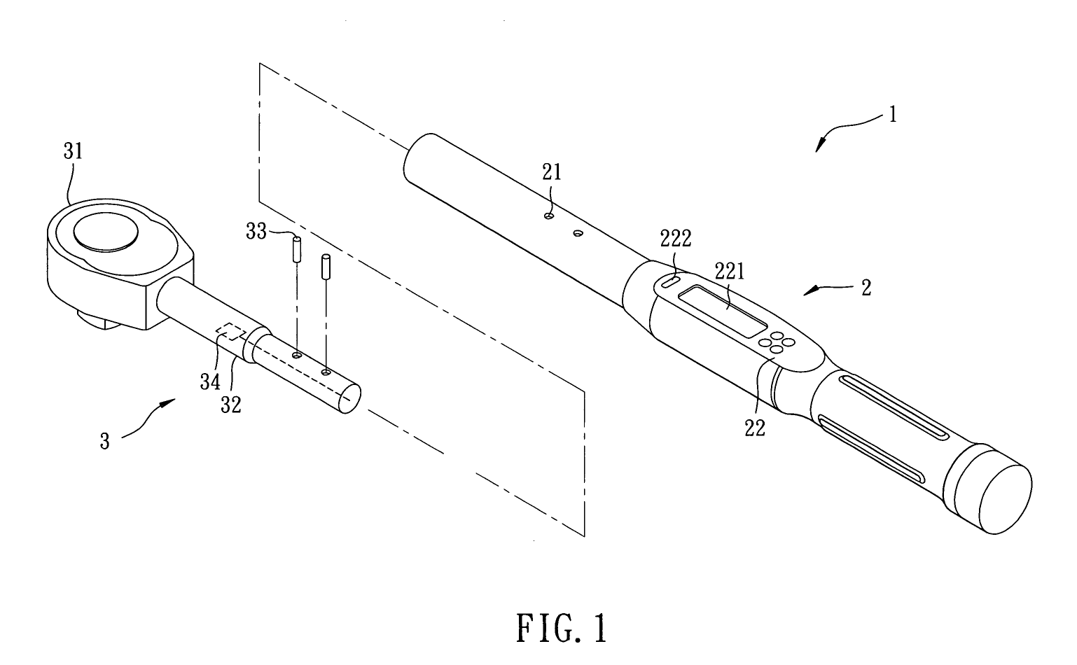

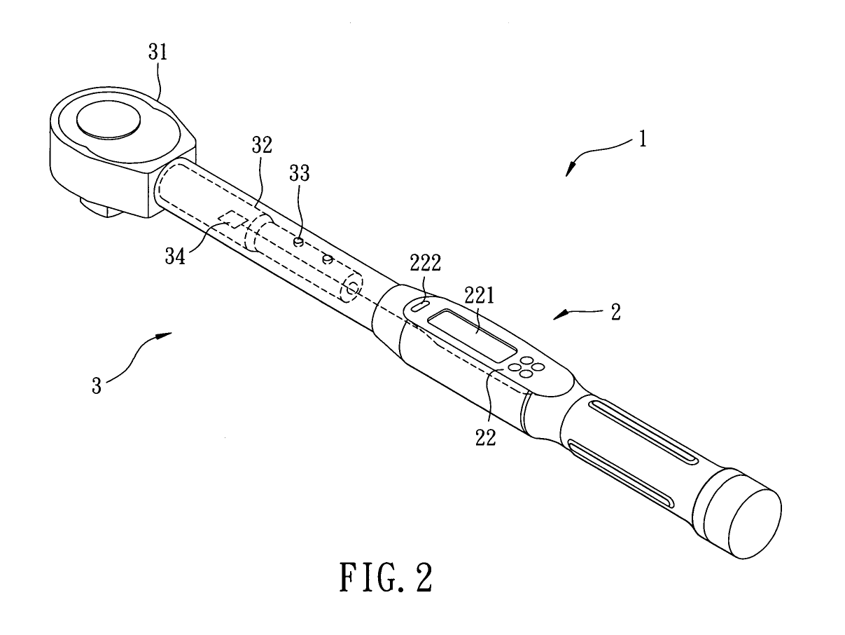

Referring to the drawings and initially to FIGS. 1 and 2, a torque wrench (1) in accordance with the present invention comprises handle (2) and a function shaft (3) longitudinally mounted to the handle (2).

The handle (2) has a first end portion provided for user to operate the torque wrench and a second end portion that is hollow for partially received the function shaft (3). The handle (2) has two holes (21) defined in the second end portion thereof and extending to an inner periphery of the second end portion. The function shaft (3) has a head (31) provided to drive a workpiece, and a connecting rod (32) laterally extending from the head (31) and received in the second end portion of the handle (2). Two locking members (33) respectively extend through a corresponding one of the two holes (21) and inserted into the connecting rod (32) for assembling the handle (2) and the function shaft (3) after the connecting rod (32) being inserted into the second end portion.

The function shaft (3) includes a torque sensor (34) mounted in the connecting rod (32) near the head (31). The torque sensor (34) is a strain gauge or a piezoelectric switch. The torque sensor (34) is provided to sense the torque that the workpiece is applied by the torque wrench. The handle (2) further includes a counter (22) mounted in a muddle portion thereof and electrically connected to the torque sensor (34) for counting the use frequency due to a signal received from the torque sensor (34). The counter (22) includes a display window (221) and an alarm element (222) disposed on a top thereof. The display window (221) is provide to show the counting result of the counter (22) and the alarm element (222) is provided to remind the operator by lighting or buzzing when the frequency value is over the setting value. In addition, the counter (22) in accordance with the present invention can further execute a weighted operation when the torque wrench is continually loaded because it is not reciprocal when the time difference is great between two continual operations. Furthermore, the torque sensor does not take a high manufacturing cost because the torque sensor (34) only senses the torque from the head (3 1) and transmits signals to the counter (22) such that a high sensitivity is unnecessary to the torque sensor (34).

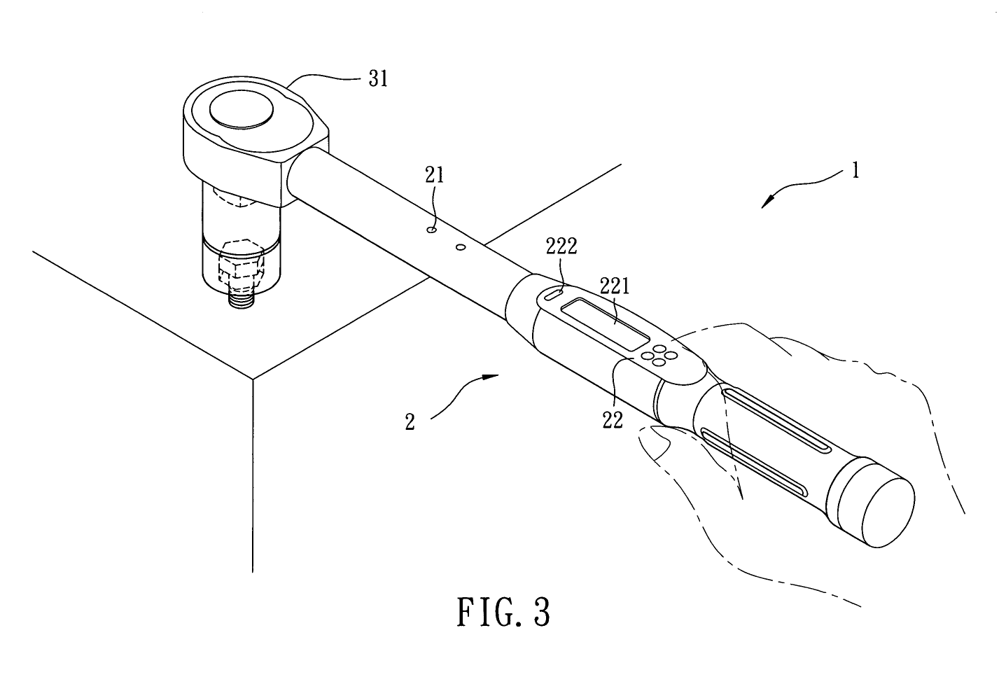

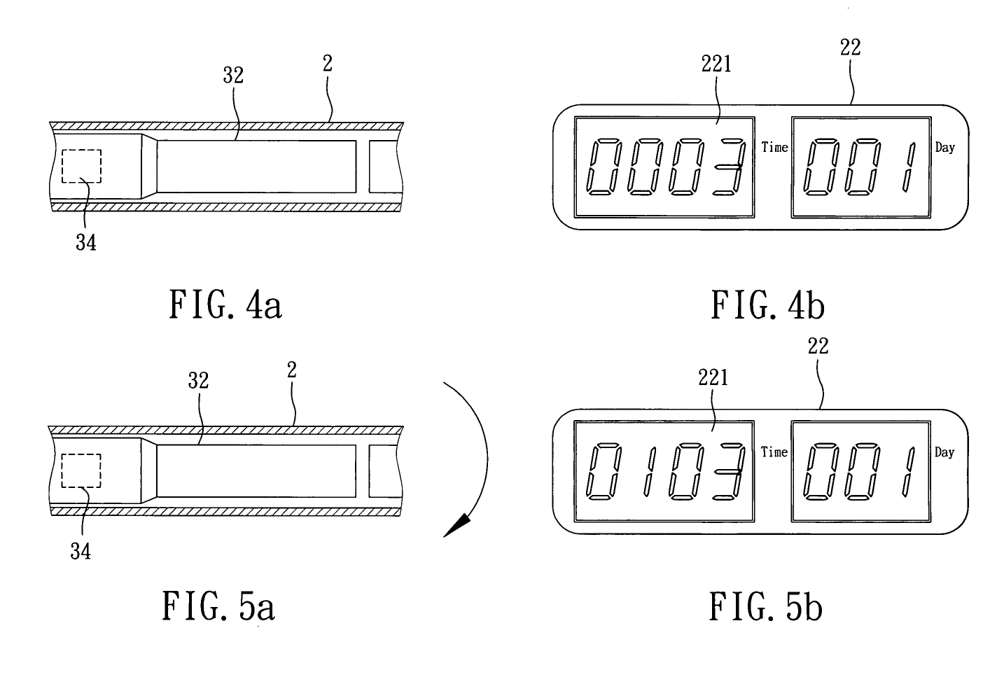

With reference to FIGS. 2 and 3, the torque sensor (34) senses the torque from the head (3 1) and transmits signals to the counter (22) when the head (31) drives a workpiece (not numbered). The display window (221) shows the accumulated operation times and continual operational time. With reference to FIGS. 4a and 4b, the operator determines the opportune moment to check or reset the torque wrench due to the data from the display window (221) of the counter (22). In addition, the alarm element (222) will remind the operator when the operational times is accumulated to a certain value. With reference to FIGS. 5a and 5b, the counter (22) will execute a weighted calculation when the torque sensor (34) transmits a continual signal to the counter (22) for a period of time. For example, the display window (221) will show an accumulated operation times as one hundred times when the torque wrench is continually loaded for eight hours. As a result, the operator can decide whether the torque wrench needs to be checked or reset after a continual operation. As a result, an accurate torque value from the torque wrench is ensured.

Although the invention has been explained in relation to its preferred embodiment, it is to be understood that many other possible modifications and variations can be made without departing from the spirit and scope of the invention as hereinafter claimed.

What is claimed is:

1. A torque wrench comprising a handle and a function shaft longitudinally mounted to the handle, the handle having a counter mounted in a middle portion of the handle, the function shaft having a head adapted to drive a workpiece and a connecting rod laterally extending from the head, the connecting rod received in and engaged to one end of the handle, the function shaft having a torque sensor mounted in the connecting rod and electrically connected to the counter for sensing a torque value from the head, whereby the counter executes a weighted compute and shows date when receiving a signal from the torque sensor.

2. The torque wrench as claimed in claim 1, wherein the counter includes a display window disposed thereon for showing a computed date from the counter.

3. The torque wrench as claimed in claim 1, wherein the counter includes an alarm element disposed thereon for reminding the operator to check the torque wrench in a suitable opportune moment.

4. The torque wrench as claimed in claim 1, wherein the torque sensor is a strain gauge.

5. The torque wrench as claimed in claim 1, wherein the torque sensor is a piezoelectric switch.

6. The torque wrench as claimed in claim 2, wherein the counter includes an alarm element disposed thereon for reminding the operator to check the torque wrench in a suitable opportune moment.

7. The torque wrench as claimed in claim 2, wherein the torque sensor is a strain gauge.

8. The torque wrench as claimed in claim 2, wherein the torque sensor is a piezoelectric switch.

9. The torque wrench as claimed in claim 3, wherein the torque sensor is a strain gauge.

10. The torque wrench as claimed in claim 3, wherein the torque sensor is a piezoelectric switch.
